(19) United States
(12) Patent Application Publication
(10) Pub. No.: US 2016/0215625 A1
(43) Pub. Date: Jul. 28, 2016

(54) TURBINE BUCKET FOR CONTROL OF WHEELSPACE PURGE AIR

(71) Applicant: General Electric Company, Schenectady, NY (US)

(72) Inventors: Rohit Chouhan, Bangalore (IN); Soumyik Kumar Bhaumik, Bangalore (IN)

(21) Appl. No.: 14/603,318

(22) Filed: Jan. 22, 2015

(51) Int. Cl. F01D 5/14; F01D 11/00

(52) U.S. Cl. CPC F01D 5/147; F01D 11/006; F05D 2220/32; F05D 2240/80; F05D 2240/30; F05D 2240/55

(57) ABSTRACT

Embodiments of the invention relate generally to rotary machines and, more particularly, to the control of wheel space purge air in gas turbines. In one embodiment, the invention provides a turbine bucket comprising: a platform portion; an airfoil extending radially outward from the platform portion; a shank portion extending radially inward from the platform portion; at least one angel wing extending axially from a face of the shank portion, the at least one angel wing including an angel wing rim extending radially upward toward the airfoil; and a plurality of voids disposed along the angel wing rim.

### BACKGROUND OF THE INVENTION

Embodiments of the invention relate generally to rotary machines and, more particularly, to the control of wheel space purge air in gas turbines.

As is known in the art, gas turbines employ rows of buckets on the wheels/disks of a rotor assembly, which alternate with rows of stationary vanes on a stator or nozzle assembly. These alternating rows extend axially along the rotor and stator and allow combustion gasses to turn the rotor as the combustion gasses flow therethrough.

Axial/radial openings at the interface between rotating buckets and stationary nozzles can allow hot combustion gasses to exit the hot gas path and radially enter the intervening wheelspace between bucket rows. To limit such incursion of hot gasses, the bucket structures typically employ axially-projecting angel wings, which cooperate with discourager members extending axially from an adjacent stator or nozzle. These angel wings and discourager members overlap but do not touch, and serve to restrict incursion of hot gasses into the wheelspace.

In addition, cooling air or “purge air” is often introduced into the wheelspace between bucket rows. This purge air serves to cool components and spaces within the wheelspaces and other regions radially inward from the buckets as well as providing a counter flow of cooling air to further restrict incursion of hot gasses into the wheelspace. Angel wing seals therefore are further designed to restrict escape of purge air into the hot gas flowpath.

Nevertheless, most gas turbines exhibit a significant amount of purge air escape into the hot gas flowpath. For example, this purge air escape may be between 0.1% and 3.0% at the first and second stage wheelspaces. The consequent mixing of cooler purge air with the hot gas flowpath results in large mixing losses, due not only to the differences in temperature but also to the differences in flow direction or swirl of the purge air and hot gasses.

### BRIEF DESCRIPTION OF THE INVENTION

In one embodiment, the invention provides a turbine bucket comprising: a platform portion; an airfoil extending radially outward from the platform portion; a shank portion extending radially inward from the platform portion; at least one angel wing extending axially from a face of the shank portion, the at least one angel wing including an angel wing rim extending radially upward toward the airfoil; and a plurality of voids disposed along the angel wing rim.

In another embodiment, the invention provides a turbine bucket comprising: a platform portion; an airfoil extending radially outward from the platform portion; a shank portion extending radially inward from the platform portion; at least one angel wing extending axially from a face of the shank portion, the at least one angel wing including an angel wing rim extending radially upward toward the airfoil; a plurality of voids disposed along the angel wing rim; and a plurality of dam members extending axially inward from the angel wing rim toward the face of the shank portion.

In yet another embodiment, the invention provides a gas turbine comprising: at least one turbine bucket extending radially outward from a rotating shaft, the at least one turbine bucket including: an airfoil extending radially outward from a platform; a shank portion extending radially inward from the platform portion; and at least one angel wing seal extending axially from a face of the shank portion, the at least one angel wing seal having an angel wing rim extending radially upward toward the airfoil; and a nozzle surface disposed radially outward from the at least one angel wing seal, the nozzle surface having a radially inwardly facing erodible portion adjacent the angel wing rim, wherein, in operation, the angel wing rim erodes a groove into the erodible portion of the nozzle surface.

In yet another embodiment, the invention provides a gas turbine comprising: a diffuser; and a last stage turbine bucket adjacent the diffuser, the last stage turbine bucket comprising: an airfoil extending radially outward from a platform portion; a shank portion extending radially inward from the platform portion; at least one angel wing extending axially from a face of the shank portion, the at least one angel wing including an angel wing rim extending radially upward toward the airfoil; and a plurality of voids disposed along the angel wing rim.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a schematic cross-sectional view of a portion of a known turbine;

FIG. 2 shows a perspective view of a known turbine bucket;

FIG. 3 shows a perspective view of a portion of a turbine bucket according to an embodiment of the invention;

FIG. 4 shows a radially inward view of a portion of the turbine bucket of FIG. 3;

FIG. 5 shows a perspective view of a portion of a turbine bucket according to another embodiment of the invention;

FIG. 6 shows a perspective view of a portion of a turbine bucket according to yet another embodiment of the invention;

FIG. 7 shows a cross-sectional side view of the turbine bucket of FIG. 6;

FIG. 8 shows a schematic view of purge air flow in a known turbine bucket;

FIG. 9 shows a schematic view of purge air flow in a turbine bucket according to an embodiment of the invention;

FIG. 10 shows a schematic view of a last stage turbine bucket and diffuser according to an embodiment of the invention;

FIG. 11 shows a graph of swirl spike profiles at a diffuser inlet plane for known turbines and turbines according to embodiments of the invention;

FIG. 12 shows a graph of total pressure spike profiles at a diffuser inlet plane for known turbines and turbines according to embodiments of the invention; and

FIG. 13 shows a schematic cross-sectional side view of a steam turbine bucket according to an embodiment of the invention.

It is noted that the drawings of the invention are not to scale. The drawings are intended to depict only typical aspects of the invention, and therefore should not be considered as limiting the scope of the invention. In the drawings, like numbering represents like elements among the drawings.

### DETAILED DESCRIPTION OF THE INVENTION

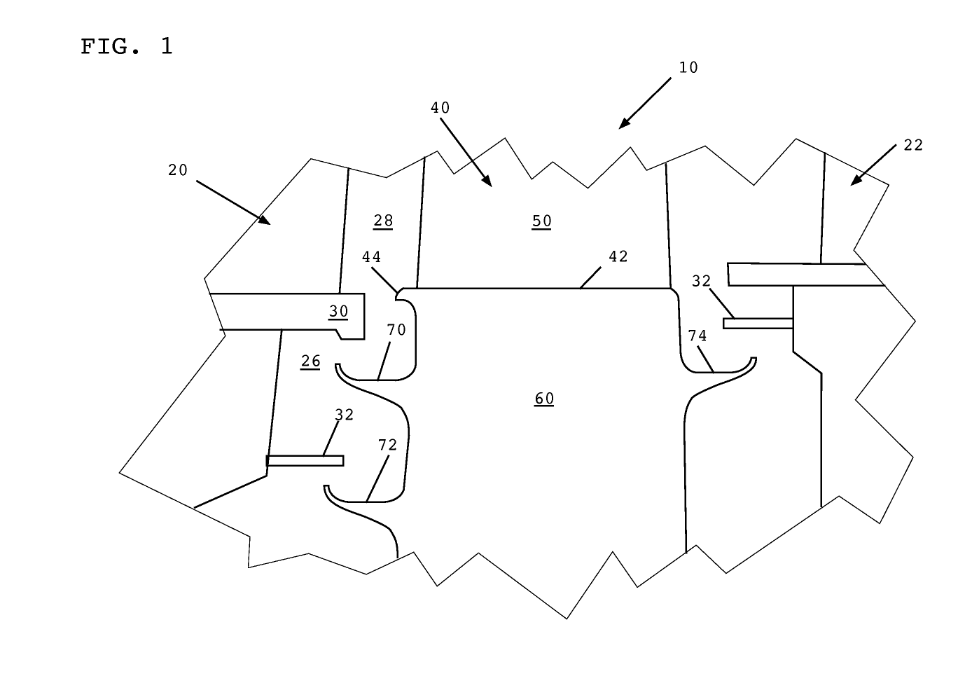

Turning now to the drawings, FIG. 1 shows a schematic cross-sectional view of a portion of a gas turbine 10 including a bucket 40 disposed between a first stage nozzle 20 and a second stage nozzle 22. Bucket 40 extends radially outward from an axially extending rotor (not shown), as will be recognized by one skilled in the art. Bucket 40 comprises a substantially planar platform 42, an airfoil extending radially outward from platform 42, and a shank portion 60 extending radially inward from platform 42.

Shank portion 60 includes a pair of angel wing seals 70, 72 extending axially outward toward first stage nozzle 20 and an angel wing seal 74 extending axially outward toward second stage nozzle 22. It should be understood that differing numbers and arrangements of angel wing seals are possible and within the scope of the invention. The number and arrangement of angel wing seals described herein are provided merely for purposes of illustration.

As can be seen in FIG. 1, nozzle surface 30 and discourager member 32 extend axially from first stage nozzle 20 and are disposed radially outward from angel wing seals 70 and 72, respectively. As such, nozzle surface 30 overlaps but does not contact angel wing seal 70 and discourager member 32 overlaps but does not contact angel wing seal 72. A similar arrangement is shown with respect to discourager member 32 of second stage nozzle 22 and angel wing seal 74. In the arrangement shown in FIG. 1, during operation of the turbine, a quantity of purge air may be disposed between, for example, nozzle surface 30, angel wing seal 70, and platform lip 44, thereby restricting both escape of purge air into hot gas flowpath 28 and incursion of hot gasses from hot gas flowpath 28 into wheelspace 26.

As shown in FIG. 1, nozzle surface 30 and discourager member 32 each serves to restrict the escape of purge air and the incursion of hot gasses. In other embodiments of the invention, a separate discourager member, similar to discourager member 32, may be provided between angel wing seal 70 and nozzle surface 30 to provide such function.

While FIG. 1 shows bucket 40 disposed between first stage nozzle 20 and second stage nozzle 22, such that bucket 40 represents a first stage bucket, this is merely for purposes of illustration and explanation. The principles and embodiments of the invention described herein may be applied to a bucket of any stage in the turbine with the expectation of achieving similar results.

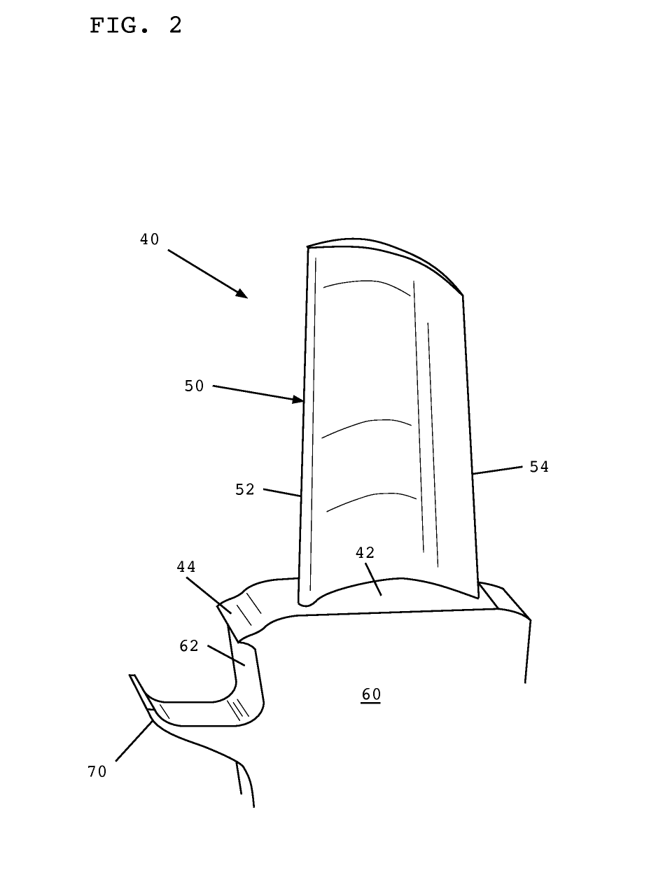

FIG. 2 shows a perspective view of a portion of bucket 40. As can be seen, airfoil 50 includes a leading edge 52 and a trailing edge 54. Shank portion 60 includes a face 62 nearer leading edge 52 than trailing edge 54, disposed between angel wing 70 and platform lip 44.

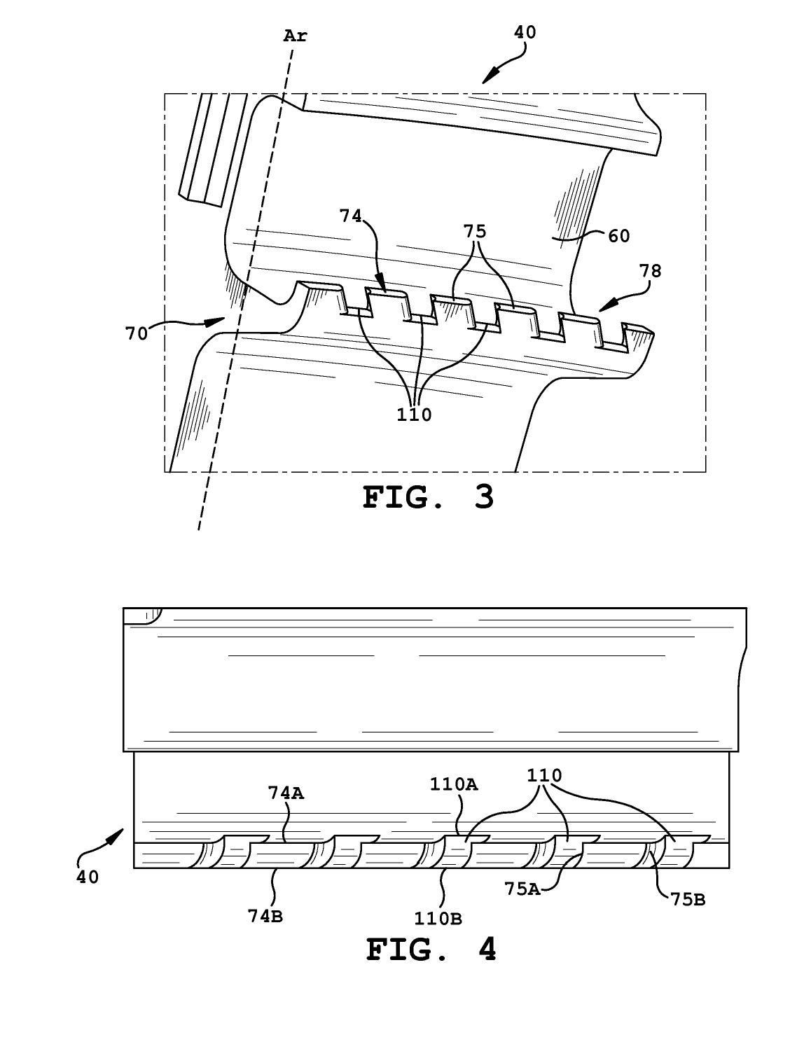

FIG. 3 shows a perspective view of a portion of a turbine bucket 40 according to an embodiment of the invention. As can be seen in FIG. 3, a plurality of voids 110 are disposed along an angel wing rim 74 at a distal end 78 of angel wing 70. Voids 110 are spaced along angel wing rim 74 such that the remaining portions of angel wing rim 74 form a plurality of column members 75. As shown in FIG. 3, voids 110 are radially angled, i.e., angled with respect to a radial axis (Ar) of turbine bucket 40, although this is neither necessary nor essential. In other embodiments of the invention, voids may be substantially parallel to a radial axis of the turbine bucket.

As shown most clearly in FIG. 4, a radially-inward looking view of turbine bucket 40, column members 75 (and correspondingly voids 110) include arcuate faces. Specifically, column members 75 include a concave face 75A (a convex face of void 110) and a convex face 75B (a concave face of void 110). As such, void 110 includes a first opening 110A along an axially inner surface 74A of angel wing rim 74 disposed laterally to a second opening 110B along an axially outer surface 74B of angel wing rim 74. It should be understood, of course, that column members and voids may have other shapes. For example, column members and voids may include rectangular, trapezoidal, or any other cross-sectional shape.

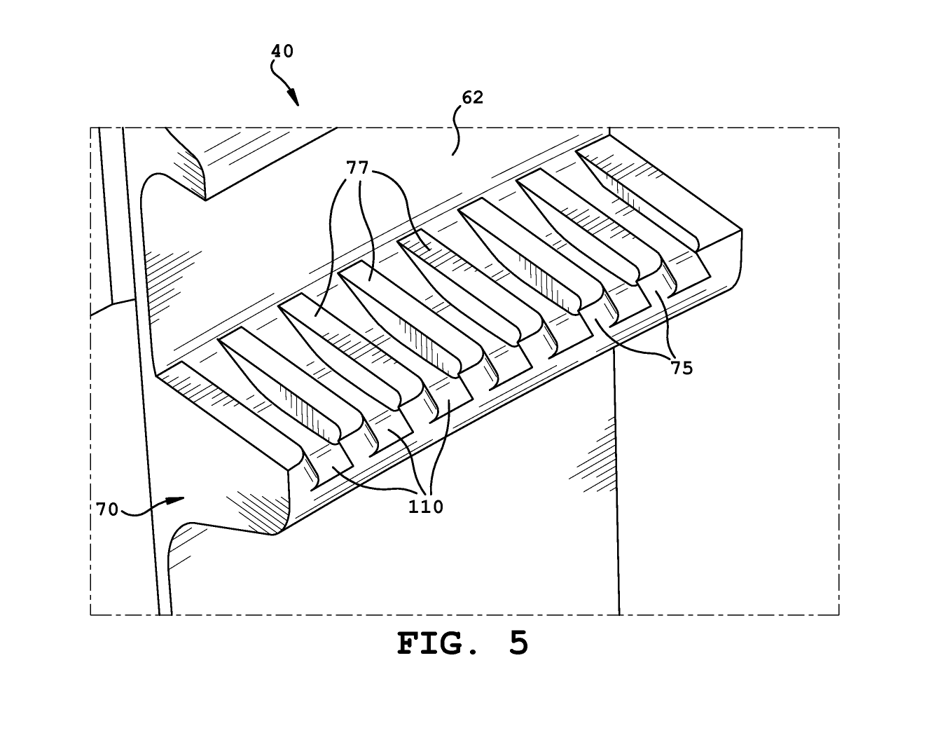

FIG. 5 shows a perspective view of a portion of a turbine bucket 40 according to another embodiment of the invention. Here, a plurality of dam members 77 extend axially from shank portion 60 to each of the plurality of column members 75. According to some embodiments, dam members 77 may be angled with respect to a radial axis of turbine bucket 40, i.e., angled positively or negatively with respect to the direction of rotation of turbine bucket 40. Similarly, according to some embodiments, dam members 77 may include one or more arcuate faces, as do column members 75, or may include rectangular, trapezoidal, or any other cross-sectional shape, such as described above.

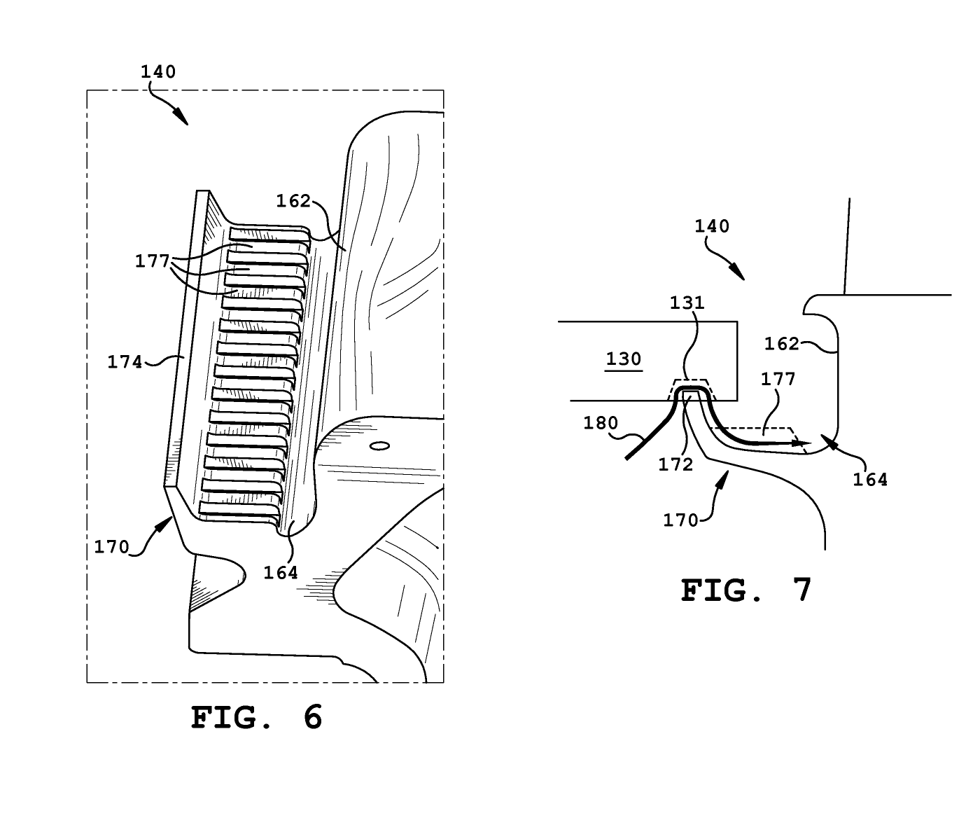

FIG. 6 shows a perspective view of a portion of a turbine bucket 140 according to another embodiment of the invention. Here, a continuous angel wing rim 174 extends upward from angel wing seal 170 and a plurality of dam members 177 extend axially from rim 174 toward but not contacting face 162, leaving a gap 164 adjacent face 162

FIG. 7 shows a cross-sectional side view of turbine bucket 140 of FIG. 6 with respect to a nozzle surface 130 according to an embodiment of the invention. In FIG. 7, nozzle surface 130 comprises or includes a porous or erodible portion along at least a radially inward surface, such that angel wing rim 174 cuts or wears a groove 131 into nozzle surface 130. The porous or erodible portion of nozzle surface 130 may comprise the material of nozzle surface 130 in a “honey comb” or similar pattern, such that the porous or erodible portion is subject to wear or erosion by angel wing rim 174. In other embodiments of the invention, the porous or erodible portion of nozzle surface 130 may comprise or include a material that is softer than the other material(s) of nozzle surface 130, such that the porous or erodible portion is similarly subject to wear or erosion by angel wing rim 174.

In operation, purge air 180 passes into groove 131 of nozzle surface 130 and then downward between dam members 177, toward face 162. Purge air 180 then flows circumferentially within gap 164, adjacent face 162, as turbine bucket 140 rotates, providing increased swirl to purge air 180.

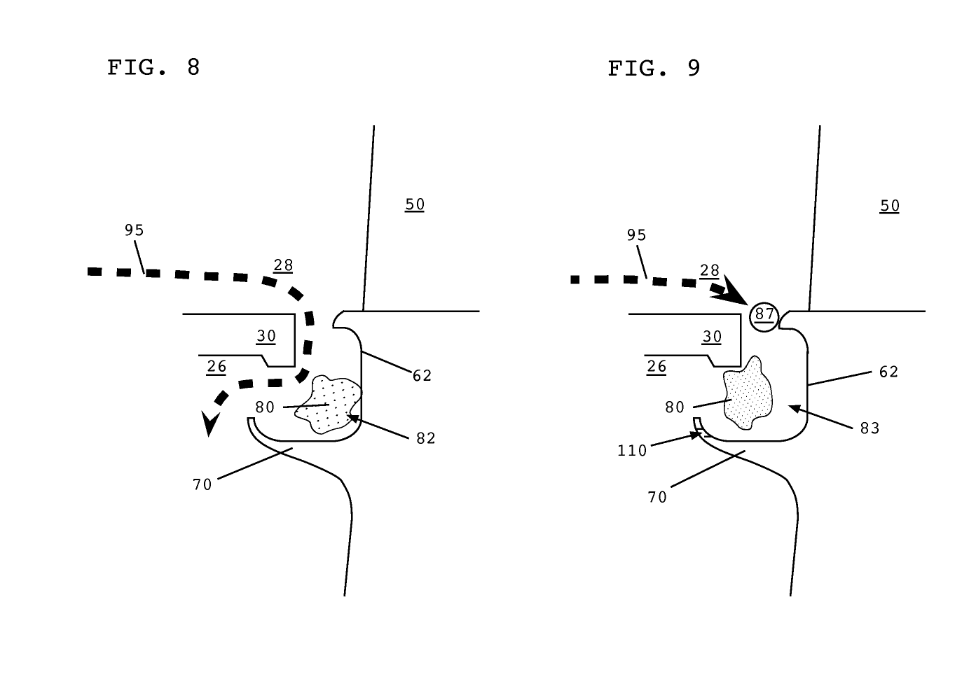

FIG. 8 shows a schematic view of purge air flow in a known turbine bucket. Purge air 80 is shown concentrated and having a higher swirl velocity in area 82, closer to face 62. In contrast, FIG. 9 is a schematic view showing the effect of voids 110 on purge air 80 according to various embodiments of the invention. Here, area 83, in which purge air 80 is concentrated and exhibits a higher swirl velocity is distanced further from face 62, as compared to FIG. 8. This, in effect, produces a curtaining effect at area 87, restricting incursion of hot gas 95 from hot gas flowpath 28 while at the same time reducing the quantity of purge air 80 escaping from wheelspace 26 into hot gas flowpath 28.

The increases in turbine efficiencies achieved using embodiments of the invention can be attributed to a number of factors. First, as noted above, increases in swirl velocity reduce the escape of purge air into hot gas flowpath 28, increases in swirl reduce the mixing losses attributable to any purge air that does so escape, and the curtaining effect induced by voids according to the invention reduce or prevent the incursion of hot gas 95 into wheelspace 26. Each of these contributes to the increased efficiencies observed.

In addition, the overall quantity of purge air needed is reduced for at least two reasons. First, a reduction in escaping purge air necessarily reduces the purge air that must be replaced, which has a direct, favorable effect on turbine efficiency. Second, a reduction in the incursion of hot gas 95 into wheelspace 26 reduces the temperature rise within wheelspace 26 and the attendant need to reduce the temperature through the introduction of additional purge air. Each of these reductions to the total purge air required reduces the demand on the other system components, such as the compressor from which the purge air is provided.

While reference above is made to the ability of angel wing rim voids to change the swirl velocity of purge air within a wheelspace, and particularly within a wheelspace adjacent early stage turbine buckets, it should be noted that angel wing rim voids may be employed on turbine buckets of any stage with similar changes to purge air swirl velocity and angle. In fact, Applicants have noted a very favorable result when angel wing rim voids are employed in the last stage bucket (LSB).

Spikes in total pressure (P_{T}) and swirl profiles at the inner radius region of the diffuser inlet are a consequence of a mismatch between the hot gas flow and the swirl of purge air exiting the wheelspace adjacent the LSB. Applicants have found that angel wing rim voids according to various embodiments of the invention are capable of both increasing P_{T} spikes at a diffuser inlet close to the inner radius while at the same time decreasing swirl spikes at or near the same location. Each of these improves diffuser performance. Angel wing rim voids, for example, have been found to change the swirl angle of purge air exiting the LSB wheelspace by 1-3 degrees while also increasing P_{T} spikes by 15-30%.

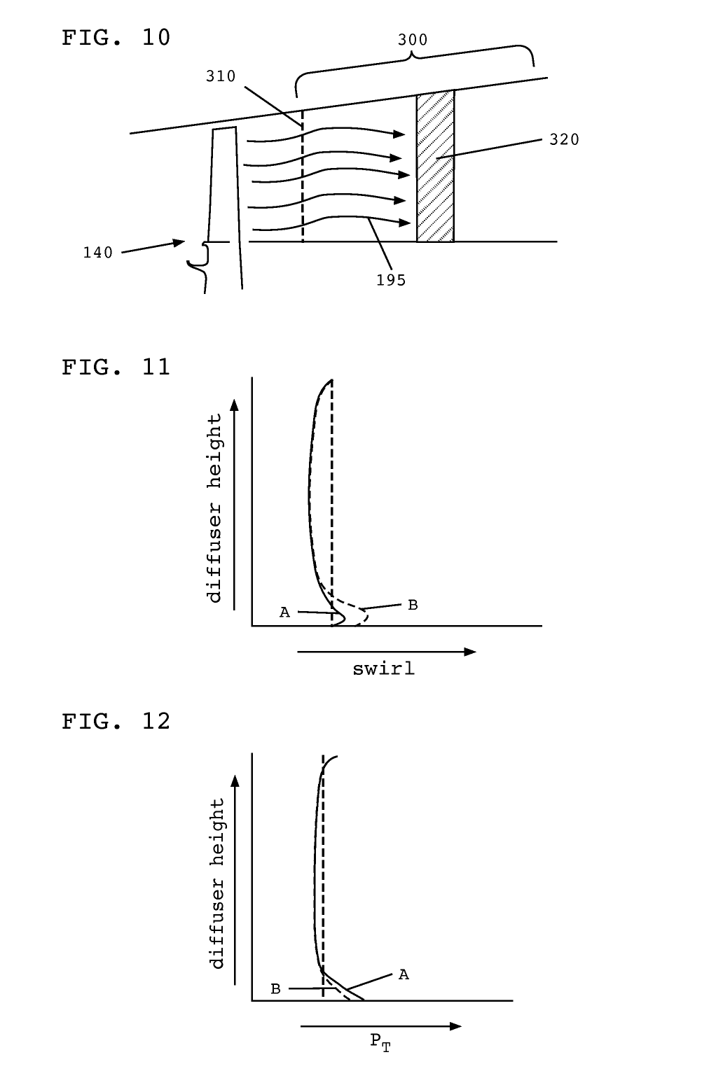

FIG. 10 shows a schematic view of a LSB 140 adjacent diffuser 300. Hot gas 195 enters diffuser 300 at diffuser inlet plane 310 and passes toward struts 320. Voids according to embodiments of the invention reduce the swirl mismatch of purge air as it combines with hot gas 195, preventing separation of hot gas 195 as it enters struts 320. At the same time, voids increase the P_{T} spike.

FIG. 11 shows a graph of swirl spike as a function of diffuser inlet plane height. Profile A represents a swirl spike profile for a turbine having angel wing rim voids according to embodiments of the invention. Profile B represents a swirl spike profile for a turbine having angel wings known in the art. Profile A exhibits a marked decrease in swirl spike at a radially inward position of the diffuser inlet plane.

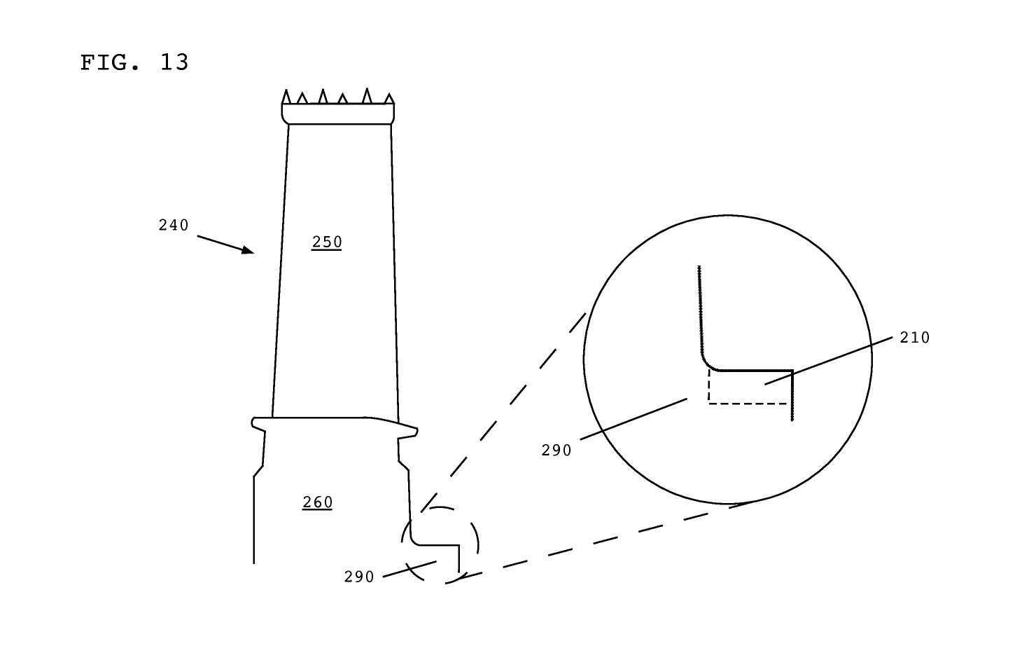

FIG. 12 shows a graph of P_{T} spike as a function of diffuser inlet plane height. Profile A represents a P_{T} spike profile for a turbine having angel wing rim voids according to embodiments of the invention. Profile B represents a P_{T} spike profile for a turbine having angel wings known in the art. Profile A exhibits an increase in P_{T} spike at a radially inward position of the diffuser inlet plane.

The principle of operation of the voids described above may also be applied to the operation of steam turbines. For example, FIG. 13 shows a schematic cross-sectional view of a steam turbine bucket 240 having an airfoil 250 and a shank 260 affixed to a disk 290. A magnified view is provided of disk 290, along which voids 210 (shown in phantom) may be deployed similarly to the voids shown in the figures above.

Steam turbines employing embodiments of the invention such as those described herein will typically realize improvements in efficiency of between 0.1% and 5%, depending, for example, on the leakage flow and the stage at which the features are employed.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

This written description uses examples to disclose the invention, including the best mode, and also to enable any person skilled in the art to practice the invention, including making and using any devices or systems and performing any related or incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A turbine bucket comprising:
a platform portion;
an airfoil extending radially outward from the platform portion;
a shank portion extending radially inward from the platform portion;
at least one angel wing extending axially from a face of the shank portion, the at least one angel wing including an angel wing rim extending radially upward toward the airfoil; and
a plurality of voids disposed along the angel wing rim.

2. The turbine bucket of claim 1, wherein, in an operative state, the plurality of voids is adapted to change a swirl velocity of purge air radially outward from the at least one angel wing.

3. The turbine bucket of claim 2, further comprising:
a platform lip extending axially from the platform portion.

4. The turbine bucket of claim 3, wherein the purge air is disposed between the platform lip and the at least one angel wing.

5. The turbine bucket of claim 1, wherein at least one of the plurality of voids include an arcuate cross-sectional shape.

6. The turbine bucket of claim 1, wherein at least one of the plurality of voids includes a rectangular shape cross-sectional shape.

7. The turbine bucket of claim 1, wherein at least one of the plurality of voids includes a trapezoidal shape cross-sectional shape.

8. The turbine bucket of claim 1, wherein at least one of the plurality of voids is angled relative to a radial axis of the turbine bucket.

9. The turbine bucket of claim 1, wherein the plurality of voids is unevenly distributed along the angel wing rim.

10. A turbine bucket comprising:
a platform portion;
an airfoil extending radially outward from the platform portion;
a shank portion extending radially inward from the platform portion;
at least one angel wing extending axially from a face of the shank portion, the at least one angel wing including an angel wing rim extending radially upward toward the airfoil;
a plurality of voids disposed along the angel wing rim; and
a plurality of dam members extending axially inward from the angel wing rim toward the face of the shank portion.

11. The turbine bucket of claim 10, wherein at least one of the plurality of dam members is disposed between two of the plurality of voids.

12. The turbine bucket of claim 10, wherein at least one of the plurality of dam members extends from the angel wing rim to the shank portion.

13. The turbine bucket of claim 10, wherein, in an operative state, the plurality of voids is adapted to change a swirl velocity of purge air radially outward from the at least one angel wing.

14. The turbine bucket of claim 10, wherein, in an operative state, at least one of the plurality of dam members is adapted to change a swirl velocity of purge air radially outward from the at least one angel wing.

15. The turbine bucket of claim 10, wherein at least one of the plurality of voids include an arcuate cross-sectional shape.

16. The turbine bucket of claim 10, wherein at least one of the plurality of voids includes a rectangular shape cross-sectional shape.

17. The turbine bucket of claim 10, wherein at least one of the plurality of voids includes a trapezoidal shape cross-sectional shape.

18. The turbine bucket of claim 10, wherein at least one of the plurality of voids is angled relative to a radial axis of the turbine bucket.

19. The turbine bucket of claim 10, wherein the plurality of voids is unevenly distributed along the angel wing rim.

20. A gas turbine comprising:
at least one turbine bucket extending radially outward from a rotating shaft, the at least one turbine bucket including:
an airfoil extending radially outward from a platform;
a shank portion extending radially inward from the platform portion; and
at least one angel wing seal extending axially from a face of the shank portion, the at least one angel wing seal having an angel wing rim extending radially upward toward the airfoil; and
a nozzle surface disposed radially outward from the at least one angel wing seal, the nozzle surface having a radially inwardly facing erodible portion adjacent the angel wing rim,
wherein, in operation, the angel wing rim erodes a groove into the erodible portion of the nozzle surface.
